(19) United States
(12) Patent Application Publication
(10) Pub. No.: US 2002/0120934 A1
(43) Pub. Date: Aug. 29, 2002

(54) Interactive television browsing and buying method

(76) Inventor: Marc Abrahams, San Diego, CA (US)

Correspondence Address: FROMMER LAWRENCE & HAUG LLP, 745 FIFTH AVENUE, NEW YORK, NY, 10151, US

(21) Appl. No.: 09/796,286

(22) Filed: Feb. 28, 2001

(51) Int. Cl. H04N 7/173; H04N 5/445

(52) U.S. Cl. 725/60; 725/109; 725/2

(57) ABSTRACT

An apparatus and method thereof for interactively browsing and buying products shown in television programs. The apparatus displays a program to be interactively viewed on a video display. The viewer can select various products shown within the program for further information or to purchase a product. When a product is selected, a window containing hypertext links corresponding to that selection is superimposed onto the video display. The viewer can then select the links to receive additional information or order the product. The apparatus can be used to select a single product, all currently displayed products, or products within a general area on the display.

### BACKGROUND OF THE INVENTION

1. Field of the Invention

The present invention relates generally to an apparatus and method for interactively browsing and buying products shown in television programs.

2. Description of the Related Art

Recent advances in digital video media along with the rapid development of e-commerce presents new opportunities for interactive entertainment programming. Interactivity requires a two-way real-time means of communication between the viewer and a video program. For example, a viewer must be able to input requests and the video program must be able to respond in real-time. Digital media that could be modified for interactive use include digital movies, DVD, digital television, and internet streaming video.

Many home electronic devices are now enabled for interactive use. These devices include set-top boxes (STBs), televisions, computers, VCRs, DVDs, digital stereo systems, etc. . . Interactivity can be predicated on the use of a cable modem, phone modem, ISDN line, or simply by using self-contained (or internal) communication means. Examples of the type of electronic devices that bring together the necessary elements for interactivity are computers with DVD and streaming video and set-top boxes (STBs).

Electronic commerce (e-commerce) is a means for marketing products over the internet. In general, this is accomplished through the use of websites. A consumer connects (links) his/her local browser to a remote website. The website contains information corresponding to a product of interest and that information is displayed to the consumer on his/her browser. Often, the website provides the consumer with the opportunity to purchase the product.

Advertisers have long used product placements to market their products. Product tie-ins can be found in movies, television programs, internet sites, etc. . . However, there is currently no system available which combines product placement with interactive electronic devices and digital video media, in a manner akin to advertisements.

Therefore, a need exists for a method of selecting objects within a video program to obtain further information about the selected objects. In addition, a need exists for interactively browsing and purchasing products that appear in video programs. Moreover, an apparatus implementing such a method should be operable in real-time so that program viewing is not interrupted.

### OBJECTS OF THE INVENTION

It is therefore an object of the present invention to allow viewers to select objects shown within a video program for further information concerning the selected objects.

It is another object of the present invention to interactively browse and buy products shown in television programs.

Other objects and advantages of the invention will in part be obvious and will in part be apparent from the specification and the drawings.

### SUMMARY OF THE INVENTION

To attain the above-mentioned objects, the invention provides a method for interactively browsing and buying products shown in television programs. The method displays a program to be interactively viewed on a video display. An object within the displayed program can be selected by the viewer using a pointer displayed on the video display. The selected object is identified on the basis of selection information by searching a database of prestored program selection information. A window is superimposed onto the displayed program to display at least one link corresponding to the identified object. The viewer can select a link using the pointer and the method performs the link operation corresponding to the selected link. The link operation can be either to fetch information corresponding to the identified object from the location indicated by the link and display the information within the superimposed window, or to fetch purchase information corresponding to the identified object from the location indicated by the link, display the purchase information within the superimposed window, and offer the viewer the opportunity to purchase the identified object. Further, the selection information can comprise a program name, a program counter, and coordinates corresponding to the location of the selection with said video display.

A first embodiment of the invention is a method wherein the object is a product being pointed to by the pointer within the displayed program at the time the selection is made.

A second embodiment of the invention is a method wherein the object is all products currently being displayed within an area of the video display around the pointer.

A third embodiment of the invention is a method wherein the object is all products currently being displayed within the displayed program.

To further attain the above-mentioned object, the invention also provides an apparatus for interactively browsing and buying products shown in television programs. The adaptable user interface has a video display for displaying a program to be interactively viewed. A selector is provided for selecting an object within the displayed program using a pointer displayed on the video display. An identifier identifies the object on the basis of selection information by searching a database of prestored program selection information. A window display superimposes a window onto the displayed program to display at least one link corresponding to the identified object. The selector is used to select a link using the pointer; and a link operation corresponding to the selected link is performed. The link operation can be either to fetch information corresponding to the identified object from the location indicated by the link and display the information within the superimposed window, or to fetch purchase information corresponding to the identified object from the location indicated by the link, display the purchase information within the superimposed window, and offer the viewer the opportunity to purchase the identified object. Further, the selection information can comprise a program name, a program counter, and coordinates corresponding to the location of the selection with said video display. The apparatus optionally comprises a transmitter for transmitting information to and receiving information from the selected link and the database may be external to the apparatus.

### BRIEF DESCRIPTION OF THE DRAWINGS

For a more complete understanding of the invention, reference is made to the following description and accompanying drawings, in which:

FIG. 1 is a system block diagram of an interactive television system using a set-top box;

FIG. 2 is a functional block diagram of a digital set-top box suitable for use with the present invention;

FIG. 3 is an illustration of a display with picture-in-picture window according to the first embodiment of the present invention;

FIG. 4 is an illustration of a display with picture-in-picture window according to the second embodiment of the present invention;

FIG. 5 is an illustration of a display with picture-in-picture window according to the third embodiment of the present invention; and

FIG. 6 is a flowchart showing the process of interactively selecting and displaying objects in a program according to the present invention.

### DETAILED DESCRIPTION OF PREFERRED EMBODIMENTS

The preferred embodiments of the apparatus and method according to the present invention will be described with reference to the accompanying drawings.

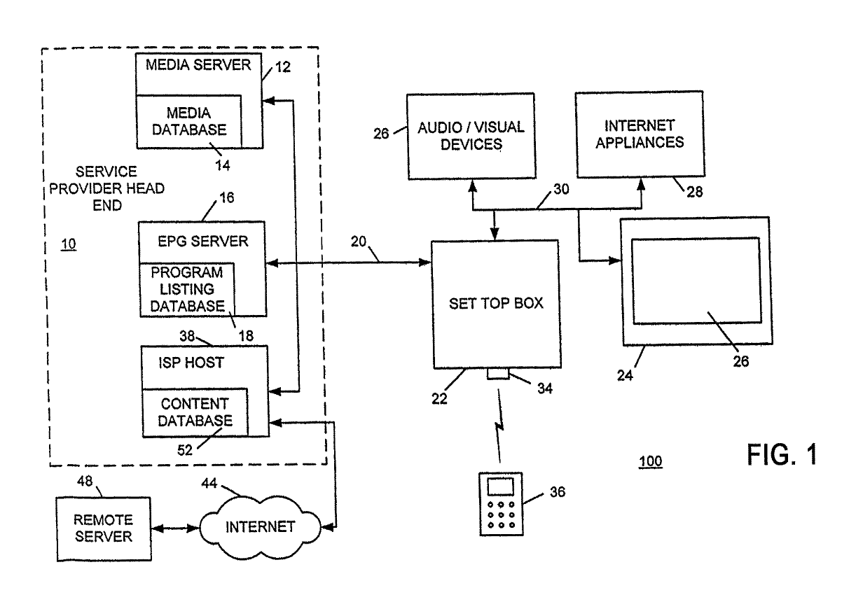

Referring to FIG. 1, a block diagram for an exemplary interactive cable or satellite television (TV) system 100 is shown. Such a system 100 is typical of the type of end-user device to which the present invention can be applied. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bi-directional communication over a transmission medium 20 in the case of a cable STB 22. In other embodiments, bi-directional communication can be effected using asymmetrical communication techniques possibly using dual communication media—one for the uplink and one for the downlink. In any event, the STB 22 can have its own Universal Resource Locator (URL) assigned thereto to provide for addressability by the head end and users of the Internet.

The media server 12 and EPG server 16 are coupled by transmission medium 20 to a set top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB.

The exemplary system 100 further includes a TV 24, such as a digital television, having a display 26 for displaying programming, an EPG, etc. . . The STB 22 may be coupled to the TV 24 and various other audio/visual devices 26 and Internet Appliances 28 by an appropriate interface 30, which can be any suitable analog or digital interface. In one embodiment, interface 30 conforms to an interface standard such as the Institute of Electrical and Electronics Engineers (IEEE) 1394 standard. The STB 22 may include a central processing unit (CPU) and memory such as Random Access Memory (RAM), Read Only Memory (ROM), flash memory, mass storage such as a hard disc drive, floppy disc drive, optical disc drive or may accommodate other electronic storage media, etc. . . Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's AperiosTm real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. . . In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g. using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

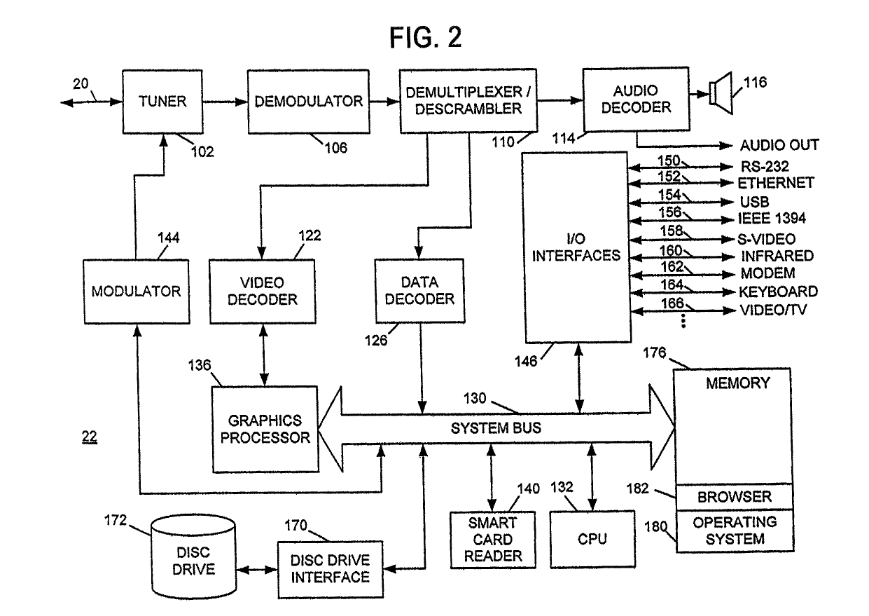

Referring now to FIG. 2, a typical system configuration for a digital set-top box 22 is illustrated. In this exemplary set-top box, the transmission medium 20, such as a coaxial cable, is coupled by a suitable interface to a tuner 102. Tuner 102 may, for example, include a broadcast in-band tuner for receiving content, an out-of-band (0013) tuner for receiving data transmissions and a return path tuner for providing an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g. audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g. stereo or home theater multiple channel audio systems) or other audio system 116 (e.g. stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card”, often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bi-directional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the tuner (operating as a return path OOB tuner) and out through the transmission medium 20. This capability is used to provide a mechanism for the STB 22 and/or its user to send information to the head end (e.g. service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of 1/0 devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire or i-link) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc. . .

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bi-directional communication via the DOCSIS cable modem with the STB 22 being identified by an unique URL (Universal Resource Locator).

A PS/2 or other keyboard mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also, include floppy disc drives, CD ROM drives, CD R/W drives, DVD drives, etc. . . CPU 132, in order to operate as a computer, is coupled through the system bus 130 to memory 176. Memory 178 may include a combination any suitable memory technology including Random Access Memory (RAM), Read Only Memory (ROM), Flash memory, Electrically Erasable Programmable Read Only Memory (EEPROM), etc. . .

While the above exemplary system including STB 22 is illustrative of the basic components of a digital set-top box suitable for use with the present invention, the architecture shown should not be considered limiting since many variations of the hardware configuration are possible without departing from the present invention.

In general during operation of the STB 22, an appropriate operating system 180 such as Sony Corporation's Aperios™ real time operating system is loaded into, or is permanently stored in, active memory along with the appropriate drivers for communication with the various interfaces. Along with the operating system and associated drivers, the STB 22 usually operates using browser software 182 in active memory or may permanently reside in ROM or EEPROM. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all include at the lowest layer various hardware interface layers. Next is an operating system layer as previously described. The software architectures of modem STBs have generally evolved to include a next layer referred to as “middleware”. Such middleware permits applications to run on multiple platforms with little regard for the actual operating system in place. Middleware standards are still evolving at this writing, but are commonly based upon JavaScript and HTML (HyperText Markup Language) virtual machines. At the top layer is the application layer where user applications and the like reside (e.g. browsing, email, EPG, Video On Demand (VOD), rich multimedia applications, pay per view, etc.). The current invention can be utilized with any suitable set-top box software architecture.

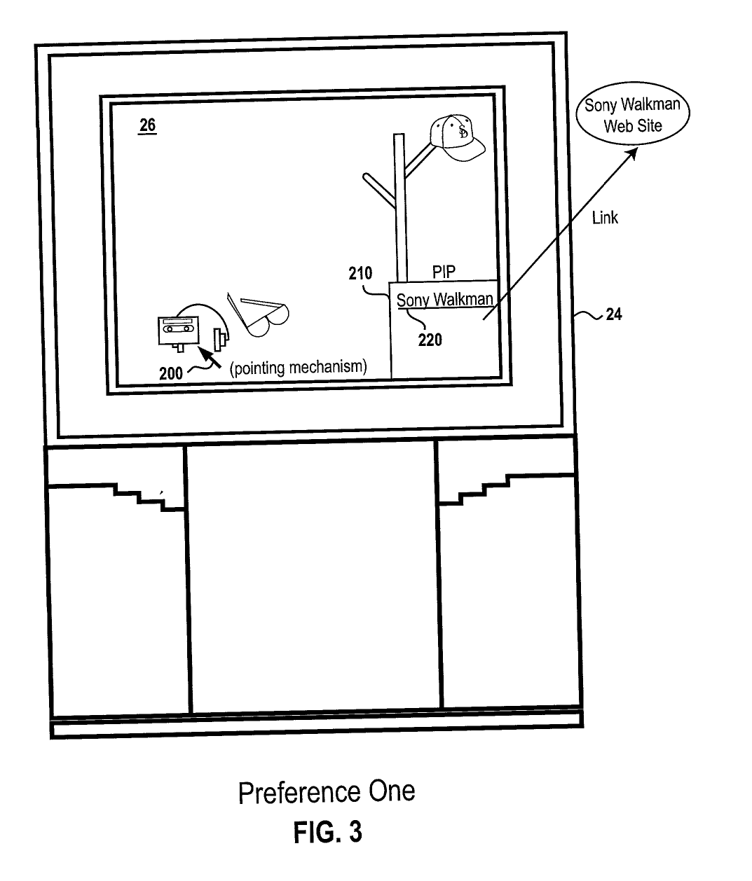

Three embodiments of the present invention will next be described with reference to FIGS. 3-5.

FIG. 3 is an illustration of a display with picture-in-picture window according to a first embodiment (Preference One) of the present invention. The display 26 and TV 24 correspond to those shown in FIG. 1. TV 24 may alternatively be a computer monitor, PDA screen, or other display device. FIG. 3 shows TV 24 as a large digital projection television. In FIG. 3, the display 26 shows a video program wherein the current scene contains a Walkman, a pair of glasses, a coat rack, and a baseball hat. A pointing mechanism (or pointer) 200 is superimposed on the display and can be positioned at any location within the display in response to a viewer's input. Viewer input is accomplished using a remote control, mouse-type device, or the like. When a viewer sees an object of interest being displayed, the viewer can move the pointer to the object and select that object for further information.

The selection of an object results in the generation of a set of selection information. The specific components of the selection information depend on the embodiment of the invention. For the first embodiment, shown in FIG. 3, the selection information comprises a program name, a program counter, and coordinates corresponding to the location of the selection within the display. The program name is simply the title of the video program being viewed. Digital video programs generally include a time stamp. This means that each frame of the video is encoded with a program counter. The selection information includes the program counter corresponding to the frame being viewed when the selection is made. The counter temporally locates the selected object within the program. The coordinates of the selection are also included as part of the selection information. Generally, these coordinates are provided as a vertical and horizontal pixel location or X,Y coordinate position within a displayed video frame. The values may either correspond to the recorded video format or the display format.

The selection information is then compared to program selection information that is prestored in a database. In general, the program selection information comprises a set of information fields having a format similar to that of the selection information and corresponding to those objects within the video program that are selectable. The program selection information additionally comprises related links to be displayed in response to the selection. The generation and content of the program selection information is discussed below in more detail. If the selection information matches an entry in the program selection information then the object has been identified.

Once a selected object has been identified, a window is generated and superimposed on the display. This window is generically called a pop-up window or picture-in-picture (PIP) window. The related links from the program selection information corresponding to the selected object are shown in the window. In FIG. 3, the PIP window 210 is located in the lower right comer of the display and contains a link 220 corresponding to the Sony Walkman object being displayed.

The related links are generally universal resource locator (URL) links corresponding to internet addresses (websites) having additional information about the selected object. The viewer can position the pointer over a link displayed in the window and select the link. The invention will access the address identified by the link and retrieve and display any pertinent information in the window. This information can be a product specification or purchasing information.

The present invention is not limited to the displayed objects, window, and links shown in FIG. 3 and should not be interpreted as being limited by these examples.

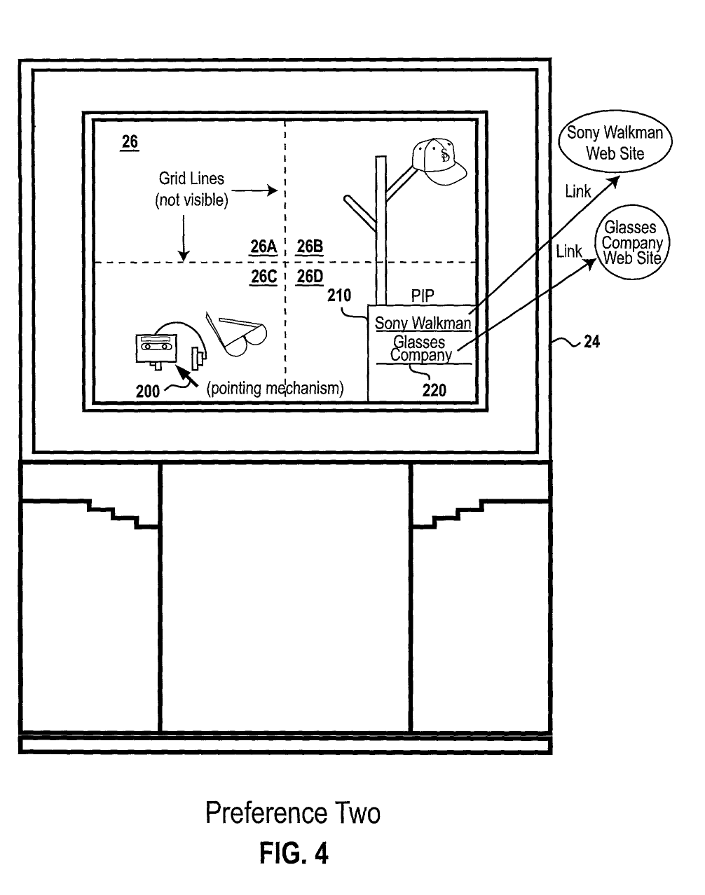

FIG. 4 is an illustration of a display with picture-in-picture window according to the second embodiment (Preference Two) of the present invention. As in FIG. 3, the display 26 and TV 24 correspond to those shown in FIG. 1. For this embodiment the display area is subdivided into a number of regions. For example, FIG. 4 shows the display 26 as four quadrants 26A-26D. The invention should not be construed as being limited to the use of just four regions. In this embodiment, the viewer need only position the pointer 200 to the same region as the object of interest and select the region.

As in the previous embodiment, a selection results in the generation of a set of selection information. The selection information comprises a program name, a program counter, and coordinates corresponding to the location of the selection within the display. The selection information is then compared to program selection information that is prestored in a database. For the second embodiment, the program selection information contains the range of coordinates corresponding to each region. The selection information is matched to the program selection information corresponding to the region within which the selection was made. If a match occurs, the superimposed window that is displayed will contain links to all objects that are located within the selected region. In FIG. 4, the PIP window 210 contains links 220 corresponding to both the Sony Walkman and glasses objects being displayed. The viewer then chooses the desired link from those being displayed. Again, the invention will access the address identified by the selected link and retrieve and display any pertinent information in the window.

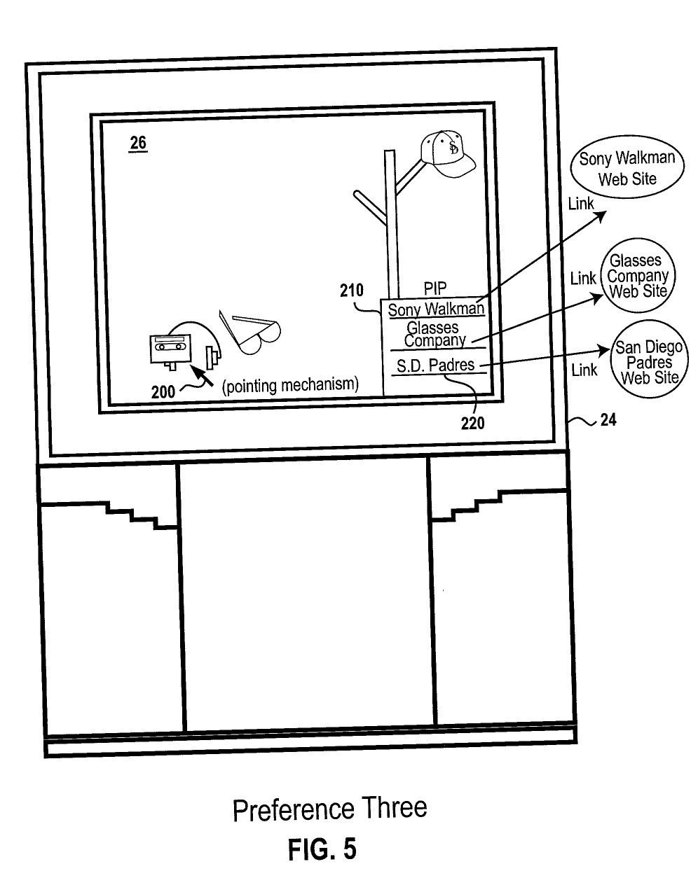

FIG. 5 is an illustration of a display with picture-in-picture window according to the third embodiment (Preference Three) of the present invention. As in FIG. 3, the display 26 and TV 24 correspond to those shown in FIG. 1. For this embodiment the video program has been subdivided into a number of scenes. In this embodiment, the viewer need only make a selection, anywhere within the display, during the scene in which the object of interest is shown.

As in the previous embodiment, a selection results in the generation of a set of selection information. The selection information comprises a program name and a program counter. The selection information is then compared to program selection information that is prestored in a database. For the third embodiment, the program selection information contains the program counter range corresponding to each scene. The selection information is matched to the program selection information corresponding to the scene within which the selection was made. If a match occurs, the superimposed window that is displayed will contain links to all objects that are located within the selected scene. In FIG. 4, the PIP window 210 contains links 220 corresponding to the Sony Walkman, the glasses and the baseball hat objects being displayed. The viewer then chooses the desired link from those being displayed. Again, the invention will access the address identified by the selected link and retrieve and display any pertinent information in the window.

Further features for any embodiment of the present invention include that the database containing the program selection information can be considered part of the invention or be an external device. The invention may additionally comprise a transmitter for transmitting information to and receiving information from selected links.

The generation and content of the program selection information is now discussed. Since each video program is different, the program selection information corresponding to each different video program will necessarily be unique. It is not likely that two video programs will incorporate the same products at exactly the same time in the same location. Therefore, a unique set of program selection information must be generated for each video program. Moreover, because the invention uses the video program itself as a means of marketing products in a manner akin to advertisements, more than one set of program selection information might need to be created for each program. For example, one set might be used for broadcast programs while another set is used for rented videos and still others might be generated for reruns that are shown several years after the original broadcast. Thus, several sets of program selection information might be required for each video program.

Each set of program selection information comprises groups of related data fields corresponding to a single video program. Each selectable product within the program having a group of related data field entries. The exact composition of the data fields is dependent on the intended embodiment of the invention used and on the information to be shown to the viewer. Additional fields can be added to the data if needed or desired for marketing, etc. . . One exemplary composition comprises data fields corresponding to the program name, the program counter, object (product), coordinates (or scene), and related links. Thus, if a given program contained twenty selectable products then the program selection information would have twenty groups each with an entry in each data field. Sets of program selection information are prestored in an object oriented or relational database that can be accessed by an application or computer graphic interface controlled by a web server.

Generating a set of program selection information for the first embodiment of the invention requires that the coordinate bounds of each selectable object within the program be determined. Furthermore, if the object moves during the time when it is selectable then the coordinates also need to be related to the program counter. Since the video program is digital, this information can be compiled using an automated contour/pattern detection program. The details of such a detection program are outside the scope of this invention. For some programs, a person could meticulously compile the information by hand. For example, in short programs with only a few relatively well defined products.

It is easier to generate the program selection information for the second embodiment of the invention. This is because only a predetermined number of regions need to be defined. Once the bounds of these regions have been determined it is a simple matter of determining which objects appear within those bounds. This process can be done automatically or by a person.

Similarly, the third embodiment simply requires the scenes to be defined and related to the program counter. The producers of the program selection information simply determine what time span constitutes a scene and input the products that are selectable during that scene.

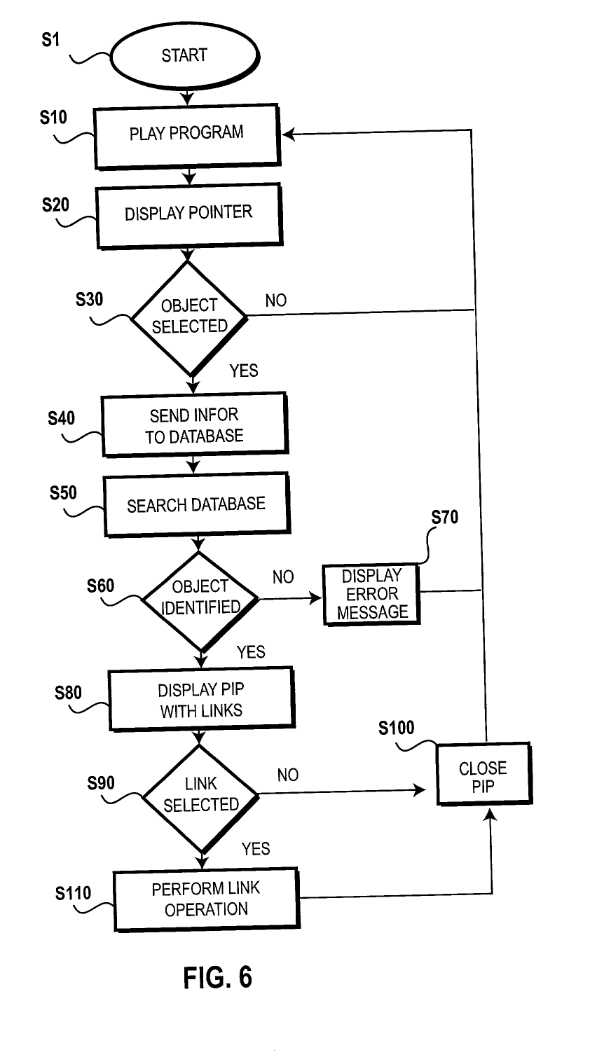

FIG. 6 is a flowchart showing the process of interactively selecting and displaying objects in a program according to the present invention. Step S1 is simply the start of the process and may correspond to turning the apparatus on. At this point, the program is played S10 and a pointer is displayed over the program S20. The invention monitors the display pointer to determine whether an object has been selected S30. If no object has been selected the program simply continues to play. If an object has been selected, then selection information is generated and sent to the database S40 where the program selection information is stored. In step S50, the database is searched for program selection information which matches the sent selection information. If no match is found then the selected object has not been identified S60 and an error message is briefly displayed S70. If a match does occur then the selected object has been identified S60 and a picture-in-picture window is superimposed on the display S80. The PIP contains the link information from the program selection information matching the selected object. In step S90, the invention detects whether a link has been selected. If no link is selected the PIP is closed S100. If a link has been selected, then the operation corresponding to that link is performed S110. Typical link operations are to retrieve information about the selected object and display that information in the PIP and to offer the viewer the opportunity to purchase the selected object. Once the link operation has been completed, the PIP is closed S100 and the invention returns to the concurrently playing program.

The following example illustrates the operation of one embodiment of the present invention. A user having a set-top box (STB) compatible with the present invention decides to watch a broadcast television program that has been prepared in accordance with the present invention (i.e., the program contains selectable objects and program selection information has been generated). The user commences watching the program and sees a displayed object that he/she wants more information about. The user positions the pointer superimposed on the display over the object using his remote control and selects the object. The invention generates selection information and sends it to a database containing the prestored program selection information for that program. If the selection matches a selectable object, then a PIP window is superimposed on the display and an internet link corresponding to that object is displayed within the window. Note that the program continuously plays, even while the PIP window is being displayed. The user can then select the link and information about the selected object is retrieved from the link location. When the user has digested the information, the PIP window is closed and the user can continue viewing the program.

While the preferred embodiments of the present invention have been described using specific terms, such description is for illustrative purposes only, and it is to be understood that changes and variations may be made without departing from the spirit or scope of the appended claims.

What is claimed is:

1. A method for interactively browsing and buying products shown in television programs, comprising the steps of:
displaying a program to be interactively viewed on a video display;
selecting an object within the displayed program using a pointer displayed on said video display;
identifying the selected object on the basis of selection information by searching a database of prestored program selection information;
superimposing a window onto the displayed program; said window displaying at least one link corresponding to the identified object;
selecting said link using said pointer; and
performing a link operation corresponding to the selected link.

2. The method according to claim 1, wherein said link operation fetches information corresponding to the identified object from the location indicated by said link and displays said information within the superimposed window.

3. The method according to claim 1, wherein said link operation fetches purchase information corresponding to the identified object from the location indicated by said link, displays said purchase information within the superimposed window, and offers the viewer the opportunity to purchase the identified object.

4. The method according to claim 1, wherein said object is a product being pointed to by said pointer within the displayed program at the time the selection is made.

5. The method according to claim 1, wherein said object is all products currently being displayed within an area of said video display around said pointer.

6. The method according to claim 1, wherein said object is all products being displayed within a scene of the displayed program.

7. The method according to claim 1, wherein said selection information comprises a program name, a program counter, and coordinates corresponding to the location of the selection within said video display.

8. An apparatus for interactively browsing and buying products shown in television programs, comprising:
a video display for displaying a program to be interactively viewed;
a selector for selecting an object within the displayed program using a pointer displayed on said video display;
an identifier for identifying the object on the basis of selection information by searching a database of prestored program selection information;
a window display for superimposing a window onto the displayed program; said window displaying at least one link corresponding to the identified object;
said selector also for selecting said link using said pointer; and
operating means for performing a link operation corresponding to the selected link.

9. The apparatus according to claim 8, wherein said link operation fetches information corresponding to the identified object from the location indicated by said link and displays said information within the superimposed window.

10. The apparatus according to claim 8, wherein said link operation fetches purchase information corresponding to the identified object from the location indicated by said link, displays said purchase information within the superimposed window, and offers the viewer the opportunity to purchase the identified object.

11. The apparatus according to claim 8, wherein said object is a product being pointed to by said pointer within the displayed program at the time the selection is made.

12. The apparatus according to claim 8, wherein said object is all products currently being displayed within an area of said video display around said pointer.

13. The apparatus according to claim 8, wherein said object is all products being displayed within a scene of the displayed program.

14. The apparatus according to claim 8, wherein said selection information comprises a program name, a program counter, and coordinates corresponding to the location of the selection with said video display.

15. The apparatus according to claim 8, further comprising a transmitter for transmitting information to and receiving information from the selected link.

16. The apparatus according to claim 8, wherein said database is external to said apparatus.
